(19) United States
(12) Patent Application Publication
(10) Pub. No.: US 2012/0042102 A1
(43) Pub. Date: Feb. 16, 2012

(54) PORTABLE ELECTRIC DEVICE AND DISPLAY MIRRORING METHOD THEREOF

(75) Inventors: Jinyong CHUNG, Seoul (KR); Yonsuk Kim, Daejong (KR); Donghan Kim, Seoul (KR)

(73) Assignee: Samsung Electronics Co., Ltd., Suwon-si (KR)

(21) Appl. No.: 13/177,677

(22) Filed: Jul. 7, 2011

(30) Foreign Application Priority Data
Aug. 13, 2010 (KR) 10-2010-0078476

(51) Int. Cl. G06F 13/14

(52) U.S. Cl. 710/33

(57) ABSTRACT

A display mirroring method of a user device simultaneously performs an operation of transmitting compressed first source files and first display information corresponding to the first source files to another user device by wireless in response to a first type display mirroring request and an operation of decoding the first source files. A decoding result of the first source files is displayed based on the first display information, and a displaying operation of the transmitted first file source is performed in the other user device.

### CROSS-REFERENCE TO RELATED APPLICATIONS

This U.S. non-provisional patent application claims priority under 35 U.S.C. §119 of Korean Patent Application No. 10-2010-0078476, filed on Aug. 13, 2010, the entire contents of which are hereby incorporated by reference.

### BACKGROUND

1. Field of the Invention

The present disclosure herein relates to a portable electric device, and more particularly, to a portable electric device capable of sharing multimedia contents by a wireless communication and a display mirroring method of the portable electric device.

2. Description of the Related Art

Advances in digital signal processing, storage media, and transmission methods have made it possible to change from voice information services to multimedia services. Various multimedia services such as digital TV services, internet protocol television (IPTV) services, and video on demand (VOD) services, and advances in terminal technology have caused increasing demands for user devices such as portable electric devices for freely accessing and displaying multimedia contents such as digitalized videos, graphics, and audio data. Along with this, new techniques such as a wireless data sharing technology and a display mirroring technique for sharing a screen by wireless connection are applied to recent user devices.

For wireless data sharing and display mirroring, it is necessary to transmit data smoothly between remote user devices. For smooth data transmission between user devices, limiting factors such as data transmission rate, bandwidth, and power consumption should be considered. If such limiting factors as data transmission rate, bandwidth, and power consumption are not sufficiently considered, there may be a time delay between user devices during wireless data sharing or display mirroring. In addition, due to the resolution difference between user devices, the quality of a screen shared or mirrored by wireless connection may be decreased.

### SUMMARY

The present disclosure provides a portable electric device formed with a single board to simultaneously decode encoded data and transmit the encoded data.

The present disclosure provides a portable electric device capable of sharing multimedia contents by wireless without time delay or image deterioration, and a display mirroring method of the portable electric device.

The present disclosure also provides a portable electric device not requiring a transcoding operation during data transmission, and a display mirroring method of the portable electric device.

The present disclosure also provides a portable electric device that can perform bidirectional display mirroring and data sharing, and a display mirroring method of the portable electric device.

Additional aspects and utilities of the present general inventive concept will be set forth in part in the description which follows and, in part, will be obvious from the description, or may be learned by practice of the present general inventive concept

The foregoing and other features and utilities of the present general inventive concept can be achieved by providing an electronic apparatus including a transceiver, a decoding unit, and a controller to control the transceiver and the decoding unit to simultaneously transmit a source file having encoded data to an external apparatus without decoding the encoded data of the source file and decode the encoded data of the source file.

The transceiver, the decoding unit, and the controller may be embedded in a single integrated chip.

The apparatus may further include a storage unit having a single common terminal connected to the transceiver and the decoding unit of the single integrated chip such that the source file is read and simultaneously transmitted to both the transceiver and the decoding unit.

The source file comprises a first portion and a second portion, the decoding unit may receive and decode the first portion of the stored source file, and the transceiver may receive and transmit the second portion of the stored source file when the decoding unit receives and decodes the second portion of the stored source file.

The source file may be selected to be transmitted to the external apparatus according to a selection signal during decoding the first portion of the stored source file so that the second portion of the source file is simultaneously decoded and transmitted to the external apparatus.

The apparatus may further include a selection unit to generate a selection signal as a command corresponding to selection of one of mirroring modes.

The controller may select the external apparatus and read the source file and simultaneously transmit the read source file to the transceiver and the decoding unit according to the selection of the external apparatus.

The transceiver may receive a second source file having encoded data from the external apparatus, and the decoding unit may decode the encoded data of the received second source file and output the decoded data to be displayed as a second image on a screen.

The foregoing and other features and utilities of the present general inventive concept can be achieved by providing an electronic apparatus including a single integrated chip formed with a transceiver, a decoding unit, and a controller as a single monolithic body, wherein the controller to control the transceiver and the decoding unit to simultaneously transmit a source file having encoded data to an external apparatus without decoding the encoded data of the source file and decode the encoded data of the source file.

The apparatus may further include a single integrated chip having a common terminal to be connected to a storage unit storing the source file so that the transceiver and the decoding unit simultaneously receives the source file from the storage unit.

The apparatus may further include a storage unit to store the source file, wherein the controller controls the storage unit, the transceiver, and the decoding unit such that the source file is read from the storage unit and the read source file is simultaneously transmitted the transceiver and the decoding unit.

The source file may include a first portion and a second portion, the decoding unit may receive and decode the first portion of the stored source file, and the transceiver may receive and transmit the second portion of the stored source file when the decoding unit receives and decodes the second portion of the stored source file.

The apparatus may further include a selection unit to select at least one of the first portion and the second portion.

The source file may include source files, and at least one of the source files may be selected according to a selection of a selection unit connected to the single integrated chip such that the selected source file is simultaneously transmitted to the transceiver and the decoding unit.

The controller may control the transceiver to transmit the source file without decoding by the decoding unit to the external apparatus in a first mirroring mode, and the controller may control the transceiver to receive another source file from the external apparatus in a second mirroring mode.

The source file may include sub-source files, and the controller may generate a list signal representing the sub-source files, select at least one of the sub-source files, and control the selected at least one of the sub-files to be simultaneously transmitted to the transceiver and the decoding unit.

The apparatus may further include a selection unit to select the external apparatus and the source file such that the selected source file is simultaneously transmitted to the decoding unit and the selected external apparatus through the transceiver.

The foregoing and other features and utilities of the present general inventive concept can be achieved by providing an electronic apparatus including a storage unit to store a source file with encoded data, a single integrated chip connected to the storage unit, and having a transceiver, a decoding unit, and a controller to control the transceiver and the decoding unit to simultaneously receive the source file and decode the source file and transmit the source file to an external apparatus; and a display unit connected to the single integrated chip to display the decoded source file.

The transceiver may be an RF transceiver to wirelessly communicate with an external apparatus.

The apparatus may further include a housing to accommodate the storage unit, the single integrated chip, and the display unit therein, and to communicate with the external apparatus through the transceiver.

The apparatus may further include a selection unit connected to the single integrated chip to select the external apparatus and the source file.

The display unit may be a touch screen to display the decoded source file, and the selection unit may be included in the touch screen to generate a selection signal to select the apparatus and the source file.

The foregoing and other features and utilities of the present general inventive concept can be achieved by providing a method of an electronic apparatus, the method including storing a source file with encoded data in a storage unit, and transmitting the stored source file from the storage unit to a single integrated chip having transceiver, a decoding unit, and a controller to control the transceiver and the decoding unit to receive the source file and simultaneously decode the source file and transmit the source file to an external apparatus.

The method may further include displaying the decoded source file on a display unit.

The method may further include selecting the external apparatus and the source file using a selection unit connected to the signal integrated chip.

Embodiments of the inventive concept provide display mirroring methods of a user device including: performing an operation of transmitting compressed first source files and first display information corresponding to the first source files to another user device by wireless in response to a first type display mirroring request in parallel with an operation of decoding the first source files; and displaying a decoding result of the first source files based on the first display information in parallel with a displaying operation of the other user device.

### BRIEF DESCRIPTION OF THE DRAWINGS

The above and/or other aspects and features of the present general inventive concept will become apparent and more readily appreciated from the following description of the exemplary embodiments, taken in conjunction with the accompanying drawings, in which:

FIG. 1 is a view illustrating an exemplary structure of a wireless sharing system according to an embodiment of the inventive concept;

FIG. 2 is a view illustrating frequency characteristics of wireless universal serial bus (USB) that can be used for display mirroring according to an embodiment of the inventive concept;

FIG. 3 is a view illustrating exemplary overall structures of first and second user devices illustrated in FIG. 1;

FIGS. 4 through 6 are views illustrating a first type display mirroring operation according to embodiments of the inventive concept;

FIGS. 7 through 9 are views illustrating a second type display mirroring operation according to embodiments of the inventive concept;

FIG. 10 is a flowchart illustrating an exemplary bidirectional display mirroring method carried out by the first user device according to according to an embodiment of the inventive concept;

FIG. 11 is a flowchart illustrating an exemplary bidirectional display mirroring method carried out by the second user device according to an embodiment of the inventive concept;

FIGS. 12A and FIG. 12B are flowcharts illustrating an exemplary data streaming/downloading method carried out by the first user device according to embodiments of the inventive concept; and

FIG. 13 is a flowchart illustrating an exemplary data streaming/downloading method carried out by the second user device according to an embodiment of the inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. In the following description, exemplary circuit structures and operations of user devices are described, and the user devices may be changed or modified within the scope of the inventive concept. For example, in the following description of the inventive concept, an explanation is given on exemplary user devices that can compress/decompress and display digital multimedia contents such as video, graphic, and audio data transmitted through a wireless network.

During a wireless data sharing or display mirroring operation of a wireless sharing system of the inventive concept, compressed source files stored in a transmitting user device can be directly transmitted to a receiving user device before the compressed source files are decoded. That is, during the wireless data sharing or display mirroring operation, the transmitting user device (for example, a portable electric device) is not necessary to decode the compressed source files and transcode display data which are results of decoding, and the receiving user device is not necessary to decode transcoded data received from the transmitting user device. Therefore, the display mirroring operation and wireless sharing operation for sharing source files may be efficiently carried out without a time delay under limiting conditions such as the data transmission rate and bandwidth of a wireless network and power consumption limitation. In addition, display mirroring and wireless data sharing of multimedia contents may be possible without deterioration of image quality caused by the resolution of the other device. The inventive concept is not limited to the above-described examples. That is, the inventive concept may be applied to various user devices, and the wireless sharing method and display mirroring method of the inventive concept are not limited to particular user devices but may be applied to various user devices.

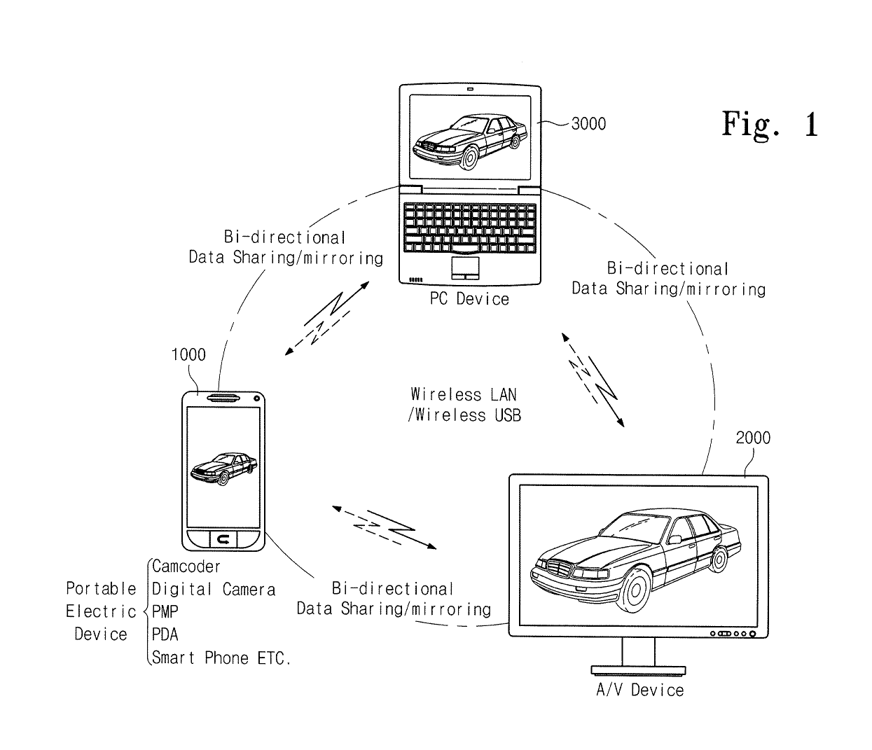

FIG. 1 is a view illustrating an exemplary structure of a wireless data sharing system according to an embodiment of the inventive concept.

Referring to FIG. 1, user devices may include a portable electric device (hereinafter referred to as a first user device 1000) such as a cellular phone, a smart phone, a personal digital assistant (PDA), a portable multimedia player (PMP), a digital camera, a camcorder, a voice recorder, an MP3 player, and a game unit, and an audio/video (NV) device (hereinafter referred to as a second user device 2000) capable of displaying TV images through a large display and reproducing multichannel audio data. In addition, the user devices may further include a third user device 3000 such as a personal computer (PC), a digital camera, a printer, and a storage medium connectable to the PC. It is possible that the first user devise 1000 may be same as at least one of the second user device 2000 and the third user device 3000, and it is also possible that the first user device 1000 is different from the second user device 2000 and the third user device 3000. The above-mentioned user devices are exemplary user devices to which the inventive concept can be applied. That is, various user devices may be used. The user devices, and the wireless sharing method and display mirroring method of the inventive concept are not limited to particular devices.

The user devices 1000, 2000, and 3000 may transmit and receive multimedia data by wireless communication. In some embodiments, the user devices 1000, 2000, and 3000 may be connected to each other by small-size, low-power-consumption, and inexpensive wireless personal area network (WPAN) technology. The WPAN technology may include ZigBee, Bluetooth, and ultra-wideband (UWB) based wireless universal serial bus (WUSB) technologies. These technologies are exemplary technologies to which the inventive concept may be applied. That is, the inventive concept may be applied to various radio transmission technologies.

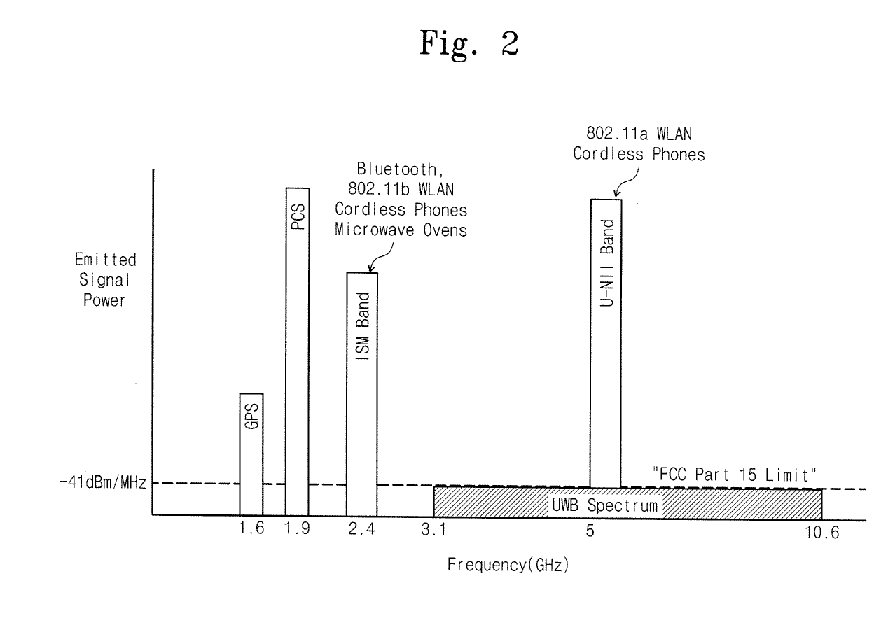

FIG. 2 is a view illustrating frequency characteristics of WUSB that can be used for display mirroring according to an embodiment of the inventive concept.

Referring to FIG. 2, UWB on which WUSB is based may be defined as radio transmission technology having a spectrum that occupies a bandwidth greater than 20 percent of the center frequency, or a bandwidth of at least 500 MHz. The most distinguished features of USB are the use of an ultra wideband and relatively low output power. That is, as shown in FIG. 2, a UWB system may be configured based on a very low spectrum power density over an extremely broad bandwidth as compared with a narrowband system or a wideband code division multiple access (CDMA) system. A UWB system can send a signal by spreading the signal over several GHz of bandwidth to prevent interference with signals of other communication systems. Therefore, a UWB system can carry out communications with less frequency limitation and low power consumption without causing interference with other narrowband signals.

Since UWB is more advantageous than wireless local area network (WLAN) and Bluetooth in features such as high transmission rate and low power consumption, UWB draws attention as communication technology between high-performance portable devices. Particularly, the low power consumption feature of UWB may be useful to solve the battery capacity problem of portable devices. In addition, the high transmission rate of UWB reaching several hundreds of Mbps may be considered as the most important merit of UWB because it allows smooth transmission of almost all kinds of data such as high-quality image data. However, due to low output power of UWB, UWB may be suitable as a service solution using WPAN rather than a service solution using a public network.

In the following description of the inventive concept, explanations will be given on examples of wireless data sharing and display mirroring that use UWB based WUSB among various wireless network technologies. However, these are only examples of the inventive concept. That is, the inventive concept is not limited to a particular wireless network but may be applied to various wireless networks. Devices communicating with each other through the wireless network and a wireless communication may have units to perform the networking and communicating operations between the devices. Since the units to perform the networking and communicating operations are well known, and also a wireless network and a wireless communication are well known, detail descriptions thereof will be omitted.

The wireless sharing system of the inventive concept may include the different kinds of user devices 1000, 2000, and 3000 as shown in FIG. 1. According to the inventive concept, wireless data sharing and display mirroring operations may be carried out among the different kinds of user devices 1000, 2000, and 3000 unidirectionally or bidirectionally.

For example, during a display mirroring operation, the first user device 1000 (such as a portable electric device) including a small display may operate as a transmitting user device, and the second user device 2000 including a display of equal or greater size may operate as a receiving user device. In this disclosure, this will be referred to as a first type display mirroring operation. In the first type display mirroring operation, a screen which is being displayed on the first user device 1000 may be shared with the second user device 2000 by wireless connection so that the same screen can be displayed on the first and second user devices 1000 and 2000.

In a display mirroring operation of the inventive concept, the second user device 2000 which is operating as a receiving user device can be changed to a transmitting user device in response to a user's request or manipulation, and the first user device 1000 which is operating as a transmitting user device can be changed to a receiving user device. In this disclosure, this will be referred to as a second type display mirroring operation. In the second type display mirroring operation, a multimedia source stored in the second user device 2000 or a screen which is being displayed on the second user device 2000 may be shared with the first user device 1000 by wireless connection so that the same screen can be displayed on the first and second user devices 1000 and 2000.

In the wireless data sharing operation and display mirroring operation of the inventive concept, compressed source files stored in a transmitting user device can be directly transmitted to a receiving user device before the transmitting user device decodes the compressed source files to display the source files (this will be described later in more detail). This source file transmission operation may be carried by WUSB based on UWB.

Since UWB is much more advantageous than WLAN or Bluetooth in features such as high transmission rate and low power consumption, it may take very short time to transmit source files from the first user device 1000 to the second user device 2000. Therefore, transmitting user device and receiving user device may decode compressed source files almost at the same time, and thus display mirroring may be performed without a time delay.

Instead of transmitting compressed source files directly from a transmitting user device, data of a screen which is being displayed on the transmitting user device (that is, data obtained by decoding compressed source files) may be transmitted to a receiving user device so as to perform a display mirroring operation. In this case, however, since the screen which is being displayed on the transmitting user device is a result obtained by decoding the source files, more data have to be transmitted. Therefore, to transmit decoded source files by wireless, the decoded source files may have to be compressed again by using a certain compression format according to a bandwidth and a transmission rate. Such an additional compressing operation for transmitting data of a display screen is called “transcoding.”

In a display mirroring method based on transcoding, a transmitting user device decodes compressed source files and performs a transcoding operation to compress the decoded compressed source files again. Then, a receiving user device has to decode the transcoded data received from the transmitting user device. However, according to the inventive concept, since compressed source files are directly transmitted to a receiving user device before the compressed source files are decoded, an additional transcoding operation is unnecessary.

In an exemplary embodiment, compressed source files stored in a transmitting user device may be decoded after the compressed source files are transmitted by wireless from the transmitting user device to a receiving user device. In another exemplary embodiment, compressed source files stored in a transmitting user device may be decoded while the compressed source files are being transmitted by wireless from the transmitting user device to a receiving user device. Decoding of compressed source files stored in a transmitting user device, and wireless transmission of the source files from the transmitting user device to a receiving user device are not limited to the orders explained in the above embodiments but may be carried out in different orders or manners.

According to the above-described configurations of the inventive concept, during wireless data sharing and display mirroring operations, before compressed source files stored in a transmitting user device are decoded, the compressed source files can be directly transmitted to a receiving user device without having to perform an additional transcoding operation. Therefore, display mirroring and wireless sharing of the source files can be effectively performed without a time delay even under limiting conditions such as the data transmission rate and bandwidth of a wireless network and power consumption limitation. In addition, since user devices can decode source files individually according to their display resolutions, decoded data can be properly displayed on the user devices according to the resolutions of the user devices without deterioration of image quality.

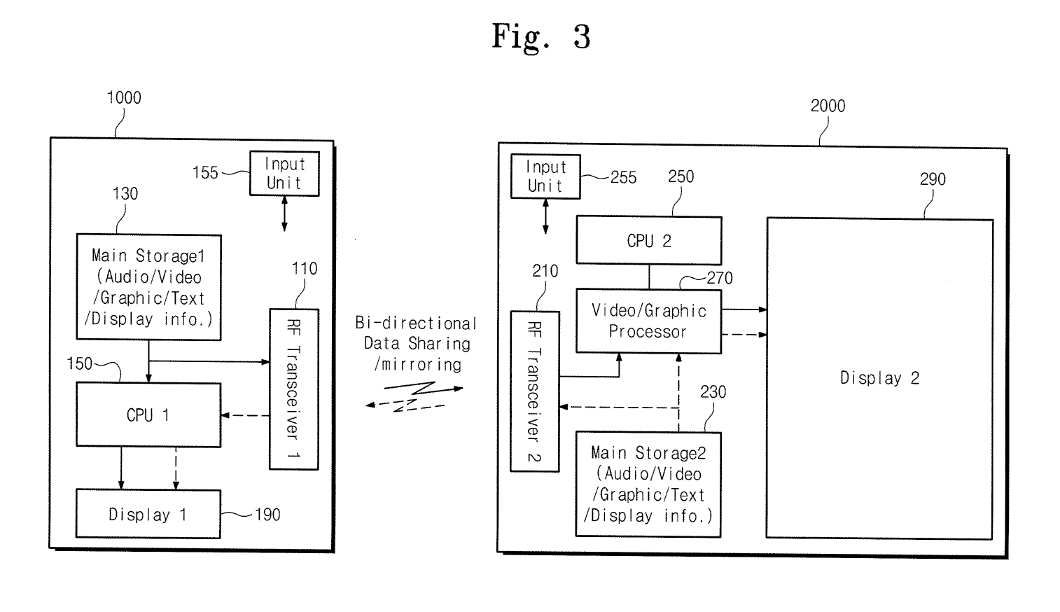

FIG. 3 is a view illustrating exemplary overall structures of the first and second user devices 1000 and 2000 illustrated in FIG. 1.

Referring to FIG. 3, the first and second user devices 1000 and 2000 may be different kinds of devices. In the example shown in FIG. 3, the first user device 1000 is a portable electric device such as a cellular phone, a smart phone, a personal digital assistant (PDA), a portable multimedia player (PMP), a digital camera, a camcorder, a voice recorder, an MP3 player, and a game unit, and the second user device 2000 is an audio/video (NV) device supporting TV image transmission and multichannel audio data. In this case, the second user device 2000 may be a non-portable device and include a large display (hereinafter referred to as a second display 290). On the other hand, the first user device 1000 may include a display (hereinafter referred to as a first display 190) smaller than the second display 290. The first and second displays 190 and 290 may be different kinds of displays having different operational characteristics. Examples of the first and second displays include a liquid crystal display (LCD), a plasma display panel (PDP), an electro luminescent display (ELD), a light emitting diode (LED) display, a vacuum fluorescent display (VFD), and a touch screen. Due to different sizes, kinds, and operational characteristics of the first and second displays 190 and 290, the first and second displays 190 and 290 may have different resolutions.

In the case where the second user device 2000 is a non-portable device, the second user device 2000 may use AC power as main power. On the other hand, the first user device 1000 which is a portable electric device may use a battery as a main power supply. Detailed structures of the first and second user devices 1000 and 2000 are as follows.

The first user device 1000 may include a first RF transceiver (first signal transceiver) 110, a first main storage 130, a first controller (or first CPU) 150, and a first display 190, and a first input unit (or first selection unit) 195.

The first main storage 130 may include a nonvolatile memory such as a flash memory to store various source files such as audio/video/graphic files and display information of the source files. In an exemplary embodiment, audio/video/graphic files may be stored in the first main storage 130 after being compressed by a predetermined method. Display information of the audio/video/graphic files may be stored in the form of metadata.

For example, video files may be compressed by a format such as Moving Picture Export Group (MPEG), Real Video, Motion-JPEG (AVI), Advanced Streaming Format (ASF), and H.264. Graphic files may be compressed by a format such as PSD, PCX, PDF, TIFF (TIF), GIF, TGA, PICT, EPS, JPEG, PNG (Portable Network Graphics), and WMF (Window Meta File). Audio files may be compressed by a format such as MP3, WAV (Waveform-Audio Format), APE, OGG, AAC (Advanced Audio Coding), and FLAC (Free Lossless Audio Codec). Display information of audio/video/graphic files may be stored in the form of metadata. In addition, source files stored in the first main storage 130 may include text files. The various kinds (or formats) of source files that can be stored in the first main storage 130 and compressing methods of the source files are not limited to particular kinds or methods but can be varied. The first main storage 130 may be configured by a hard disk drive (HDD) or semiconductor memory chips to store source files.

In the current embodiment, the first main storage 130 is configured by a flash memory (semiconductor chip) which is a nonvolatile memory. However, the kind of a memory and operational characteristics of the memory that can be used to constitute the first main storage 130 are not limited to particular kinds or characteristics but can be varied. For example, as well as a flash memory, a nonvolatile memory such as MRAM and PRAM may be used to constitute the first main storage 130. In addition, examples of memories that can be used to constitute the first main storage 130 include volatile memories such as DRAM. For example, the first main storage 130 may be constituted by at least one nonvolatile memory and at least one volatile memory, or at least two kinds of nonvolatile memories.

The number of data bits that can be stored in each memory cell of the first main storage 130 may be varied. For example, one bit may be stored in each cell of the flash memory, or a plurality of bits may be stored in each cell of the flash memory. A memory cell in which one bit is stored is called a single-bit cell or single-level cell (SLC). A memory cell in which a plurality of bits are stored is called a multi-bit cell, multi-level cell (MLC), or multi-state cell.

The flash memory may include various kinds or types of memory cells. For example, the flash memory may be a NAND flash memory or NOR flash memory, and a flash memory core and a memory controller may be included in a single chip. The flash memory may be a hybrid type flash memory in which at least two kinds of flash memories are combined.

Charge storage layers of flash memory cells may have various structures. For example, the charge storage layers of the flash memory cells may be constituted by conductive floating gates. The charge storage layers may be constituted by Si₃N₄, Al₂O₃, HfAlO, or HfSiO films. Particularly, the charge storage layers may be constituted by films that can have charge trap sites. A flash memory including such films as charge trap layers is called a charge trap flash (CTF) memory.

The first CPU 150 may control operations of the first user device 1000. In an exemplary embodiment, the first CPU 150 may be a commercially available or custom-made microprocessor. The first CPU 150 may include a decoder to decode compressed audio/video/graphic files stored in the first main storage 130 or provided from an outside device (for example, the second user device 2000 or internet service provider (ISP)). A decoding result of the first CPU 150 may be displayed on the first display 190.

In a first type display mirroring (or sharing) operation, the first user device 1000 may transmit source files (i.e., audio/video/graphic files and display information of the audio/video/graphic files) stored in the first main storage 130 directly to the second user device 2000 through the first RF transceiver 110 before the force files are decoded. In an exemplary embodiment, the first RF transceiver 110 may transmit and receive data by wireless according to UWB based WUSB.

Furthermore, in a second type display mirroring (or sharing) operation, the first RF transceiver 110 may receive source files from the second user device 2000 and transfer the received source files to the first CPU 150. The first CPU 150 may decode the source files provided from the second user device 2000 by using its decoder, and the decoding result may be displayed on the first display 190.

The first input unit (first selection unit) 195 may be connected to the first CPU 150 through wired or wireless communications. The first input unit 195 may generate signals or commands to select one of the source files to be decoded or transmitted to an external device or to select one of external devices for transmitting or receiving of the source files. The first input unit 195 may be implemented as a touch screen of the display 190 to perform the input function or selection function.

The first CPU 150 may generate a list of source files and control the display 190 to display a menu and/or a list of source files such that a user can select one of the source files using the first input unit 195. The first RF transceiver 110 may receive a list of source files stored in the second user device 2000, and the list of the source files can be displayed on the screen of the display 190 such that a user can select one of the displayed source files using the input unit 195.

The first CPU 150 may generate a list of one or more external devices including the second user device 2000 or the third user device 3000 and controls the display 190 to display the list such that a user can select one of the external devices using the first input unit 195. In this case, the source file and an ID of the selected device can be transmitted to the second user device 2000, and the second user device 2000 can recognize the ID to receive, store, and/or decode the transmitted source file to be displayed on a screen thereof.

When a source file is selected without designating or selecting a particular external device, the selected source file can be transmitted to any one of one or more external devices through the RF transceiver 110 such that a user of the respective external device can determine whether to receive, store, and/or decode the transmitted source file from the first user device 1000.

The first main storage 130 may include additional memory spaces or additional memory unit to store source files or data input from the first input unit 195 or received from the second user device 2000 through the first RF transceiver 110.

The first input unit 195 can select one of the first type display mirroring (or sharing) operation and the second type display mirroring (or sharing) operation. The first CPU 150 may generate a menu or a list of the operations and control the display 190 to display the menu or the list such that a user can select the one of the first type display mirroring (or sharing) operation and the second type display mirroring (or sharing) operation through the displayed menu or list on a screen of the display 190. When the first type display mirroring operation is selected, the source file is decoded and also transmitted to the second user device 2000. When the second type display mirroring operation is selected, a signal corresponding to the second type display mirroring operation is transmitted to the second user device 2000 such that a menu or list of source files stored in the second user device 2000 can be transmitted to the first user device 1000. The first user device 1000 displays the received menu or list on a screen of the display 190 such that selection of the source files is performed, and transmission of the selected source file is transmitted from the second user device 2000 to the first user device 1000.

The first RF transceiver 110, the first controller 150, and the decoding unit may be included in a single integrated chip. The first user device 1000 may further include a housing to accommodate the single integrated chip. The housing of the first user device 1000 may accommodate the main storage 130, the display 190, and/or the buffer 140 therein or thereon.

The second user device 2000 may include a second RF transceiver (or second signal transceiver) 210, a second main storage 230, a second controller (or second CPU) 250, a video/graphic processor 270, a second display 290, and a second input unit (or second selection unit) 295.

Like the first main storage 130 of the first user device 1000, the second main storage 230 may include a nonvolatile memory such as a flash memory. Various source files, such as audio/video/graphic files and text files, may be stored in the second main storage 230 after being compressed by a predetermined format, and display information of the source files may be stored in the second main storage 230 in the form of metadata.

In a first type display mirroring operation, the second RF transceiver 210 may receive audio/video/graphic files from the first user device 1000, and in a second type display mirroring operation, source files to be displayed on the second user device 2000 may be transmitted to the first user device 1000 through the second RF transceiver 210. In an exemplary embodiment, the second RF transceiver 210 may transmit and receive data by wireless according to UWB based WUSB.

The second CPU 250 may control operations of the second user device 2000. The video/graphic processor 270 may connected to the second CPU 250. In a first type display mirroring operation, the video/graphic processor 270 may decode source files received from the first user device 1000 or an outside device (through a wired/wireless network or an internet service provider (ISP)). In the second type display mirroring operation, compressed source files and display information of the source files stored in the second main storage 230 may be transmitted to the first user device 1000 through the second RF transceiver 210 before the source files are decoded by the video/graphic processor 270.

The second input unit (or second selection unit) 295 may be connected to the second CPU 250 through wired or wireless communications. The second input unit 295 may generate signals or commands to select one of the source files to be decoded or transmitted to an external device or to select one of external devices for transmitting or receiving of the source files. The second input unit 295 may be implemented as a touch screen of the display 290 to perform the input function or selection function.

The second CPU 250 may generate a list of source files and control the display 290 to display a menu and/or a list of source files such that a user can select one of the source files using the second input unit 295. The second RF transceiver 210 may receive a list of source files stored in the first user device 1000, and the list of the source files can be displayed on the screen of the display 290 such that a user can select one of the displayed source files using the second input unit 195

The second CPU 250 may generate a list of one or more external devices including the first user device 1000 or the third user device 3000 and controls the display 290 to display the list such that a user can select one of the external devices using the second input unit 295. In this case, the source file and an ID of the selected device can be transmitted to the first user device 1000, and the first user device 1000 can recognize the ID to receive, store, and/or decode the transmitted source file to be displayed on a screen thereof.

When a source file is selected without designating or selecting a particular external device, the selected source file can be transmitted to any one of one or more external devices through the RF transceiver 210 such that a user of the respective external device can determine whether to receive, store, and/or decode the transmitted source file from the second user device 2000.

The second main storage 230 may include additional memory spaces or additional memory unit to store source files or data input from the second input unit 295 or received from the first user device 1000 through the second RF transceiver 210.

The second input unit 195 can select one of the first type display mirroring (or sharing) operation and the second type display mirroring (or sharing) operation. The second CPU 250 may generate a menu or a list of the operations and control the display 290 to display the menu or the list such that a user can select the one of the first type display mirroring (or sharing) operation and the second type display mirroring (or sharing) operation through the displayed menu or list on a screen of the display 290. When the first type display mirroring operation is selected, the source file is decoded and also transmitted to the second user device 1000. When the second type display mirroring operation is selected, a signal corresponding to the second type display mirroring operation is transmitted to the first user device 1000 such that a menu or list of source files stored in the first user device 1000 can be transmitted to the second user device 2000. The second user device 2000 displays the received menu or list on a screen of the display 290 such that selection of the source files is performed, and transmission of the selected source file is transmitted from the first user device 1000 to the second user device 2000.

The second RF transceiver 210, the second controller 250, and the decoding unit may be included in a single integrated chip. The second user device 2000 may further include a housing to accommodate the single integrated chip. The housing of the second user device 2000 may accommodate the main storage 230, the display 290, and/or buffer 240 therein or thereon.

In the above description, a display mirroring operation among a plurality of user devices (1000, 2000) has been explained as an example of wireless data sharing. However, the display mirroring operation is merely an example of the inventive concept. That is, the wireless data sharing of the inventive concept can be applied to other operations such as a wireless data downloading operation and a wireless data streaming operation as well as the display mirroring operation. In addition, the inventive concept can be applied to other type of data such as text files as well as source files such as audio/video/graphic files.

The first user device 1000 or the second user device 2000 may include a user interface to communicate with another interface of another one of the first user device 1000 and the second user device 2000 to perform wired or wireless communications, for example, a telephone function, an Internet function, a text function, etc., other than the above describe operations. However, the present general inventive concept is not limited thereto. The above-described operations and functions can be performed a single interface or a signal transceiver.

The first user device 1000 and the second user device 2000 may recognize the data corresponding to the source file by using a particular signal included in the data or by a selecting or requesting operation of selecting or requesting the source file to be transmitted. Therefore, when the source file is selected or requested, the first user device 1000 and the second user device 2000 can recognize the source file to be transmitted between the first user device 1000 and the second user device 2000 so that the first user device 1000 and the second user device 2000 can transmit, receive, store, and/or decode the data (or signal) of the source file. It is possible that the data of the source file may include the particular signal indicating the source file to be transmitted between the first user device 1000 and the second user device 2000. Using the particular signal, the first user device 1000 and the second user device 2000 can transmit, receive, store, and/or decode the data (or signal) of the source file.

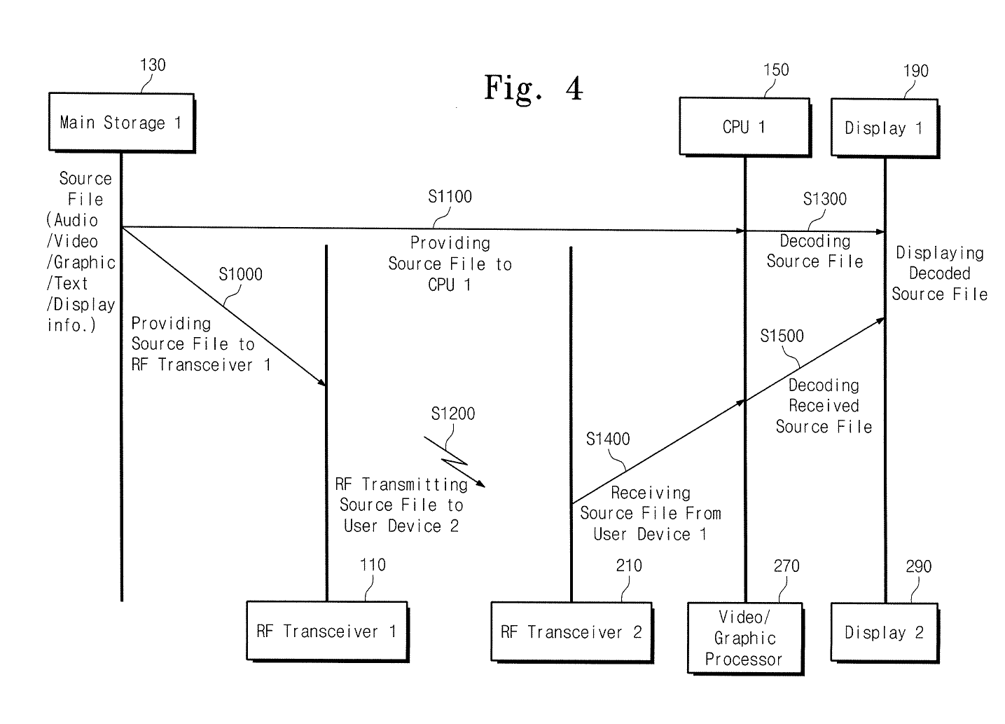

FIGS. 4 through 6 are views illustrating a first type display mirroring operation according to embodiments of the inventive concept.

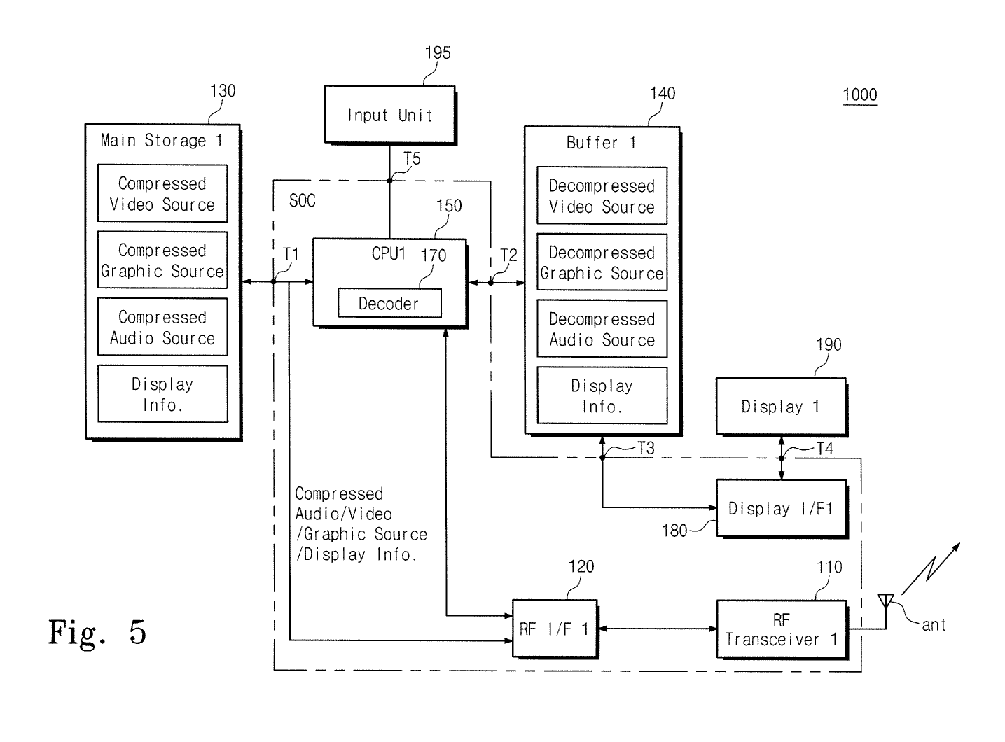

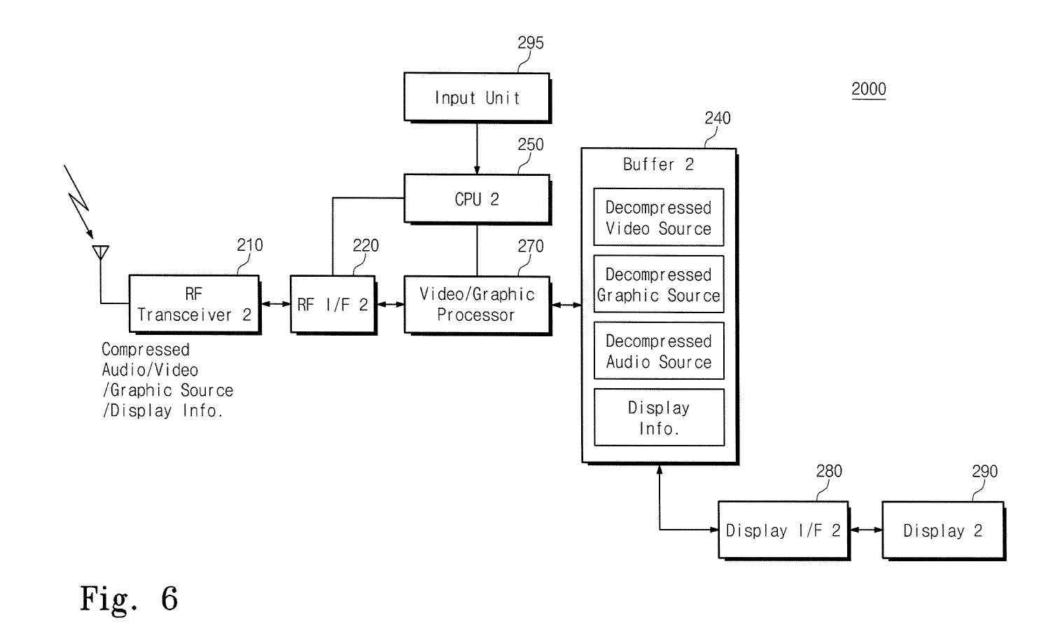

FIG. 4 illustrates data transmitting and receiving processes during a first type display mirroring operation according to an embodiment of the inventive concept. FIG. 5 illustrates a detailed structure of a first user device 1000 configured to perform a first type display mirroring operation according to an embodiment of the inventive concept. FIG. 6 illustrates a detailed structure of a second user device 2000 configured to perform a first type display mirroring operation according to an embodiment of the inventive concept.

Referring to FIG. 5, the first user device 1000 may include a first RF transceiver 110, a first RF interface 120, a first main storage 130, a first buffer 140, a first CPU 150, a decoder 170, a first display interface 180, and a first display 190. The first RF transceiver 110, the first main storage 130, the first CPU 150, and the first display 190 may have the same structures as those illustrated in FIG. 3. Thus, descriptions thereof will not be repeated.

Referring to FIGS. 4 and 5, if a user requests mirroring during a first type display mirroring operation, compressed audio/video/graphic files and display information stored in the first main storage 130 of the first user device 1000 may be provided to the first CPU 150 (S1000) and the first RF transceiver 110 through the first RF interface 120 (S1100).

The first RF interface 120 may be connected between the first RF transceiver 110 and the first main storage 130. The first RF interface 120 may multiplex the compressed audio/video/graphic files and display information stored in the first main storage 130 and provide the multiplexing result to the first RF transceiver 110. The first RF interface 120 is not limited to a particular multiplexing method. That is, the first RF interface 120 may use various multiplexing methods. The multiplexing result provided from the first RF interface 120 to the first RF transceiver 110 may be transmitted to the second user device 2000 by wireless through a wireless network such as WUSB (S1200). The first RF transceiver 110 may include the RF interface 120 to form a single unit. In an exemplary embodiment, the audio/video/graphic files to be displayed on the first user device 1000 may be provided to the second user device 2000 through the first RF transceiver 110 before or while the audio/video/graphic files are decoded by the first CPU 150.

After or while the compressed audio/video/graphic files and display information are transmitted by a wireless communication through the first RF transceiver 110, the first CPU 150 may decode the compressed audio/video/graphic files. Then, under the control of the first CPU 150, the decoding result may be displayed on the first display 190 based on the display information in operation S1300. For this, the first CPU 150 may include the decoder 170 that can decode audio/video/graphic files compressed by predetermined formats. A decoding result of the decoder 170 may be stored in the first buffer 140.

The first buffer 140 may store data temporarily while the data are transmitted between the first CPU 150 and the first display interface 180. The data may include the result of decoding of the audio/video/graphic files and the display information of the audio/video/graphic files. The first buffer 140 may include a random access memory such as a DRAM or SRAM. In the current embodiment, the first buffer 140 includes a DRAM.

The first display interface 180 may provide the audio/video/graphic files decoded by the decoder 170 and the display information of the audio/video/graphic files to the first display 190. The first display 190 may display the data provided from the first display interface 180 on a screen.

The first display interface 180 may include an LCD interface, a high-definition multimedia interface (HDMI), and a DisplayPort. HDMI is one of high-definition digital TV interface standards that can be included in various user devices such as a smart phone, a camcorder, and a digital camera. DisplayPort is a recent digital display interface standard. DisplayPort makes it possible to easily output HD audio data and HD video data and supports connection to various PCs as well as connection to a USB HUB and a webcam.

Although not shown in FIG. 5, the first user device 1000 may further include a general-purpose interface such as USB and PCI express (PCIe). The wireless sharing method of the inventive concept may be applied to other operations such as a streaming operation or a downloading operation for a device connected through the general-purpose interface as well as a display mirroring operation for the first display 190 connected through the first display interface 180.

In the case where the first user device 1000 is a portable electric device, the first RF transceiver 110, the first RF interface (I/F) 120, the first CPU 150, the decoder 170, and the first display interface 180 may be integrated into a single chip or a system on chip (SOC). In this case, the size of the first user device 1000 can be reduced owing to the integration.

As illustrated in FIG. 5, the SOC may be a circuit board with components, for example, the first RF transceiver 110, the first RF interface 120, the first CPU 150, the decoder 170, and/or the first display interface 180 which are electrically connected through a circuit thereof. The SOC may have a plurality of terminals T1, T2, T3, T4, and/or T5, for example, formed thereon. The SOC may be a signal unit, an integrated unit, or a monolithic device which is formed with the above described terminals. The first main storage 130 is connected to the terminal T1 of the SOC. The terminal T1 of the SOC may be a common terminal through which data or signal, for example, the source file, can be transmitted from the first main storage 130 to both the first CPU 150 and the RF I/F 120. The data or signals, for example, a source file received from the second user device 2000 can be transmitted to the first main storage 130 through the common terminal T1.

The terminals T2 and T3 can be used to connect the SOC and the buffer 140. The terminal T4 can be used to connect the SOC and the display 190. The terminal T5 can be used to connect the SOC and the first input unit 195. When the first input 195 is formed with the display 190, the terminal T4 can be used to connect the SOC and both the display 190 and the first input unit 195. In this case, the terminal T5 can be omitted. However, the present general inventive concept is not limited thereto. The terminal T5 can be used to connect the SOC and other component or device to receive data or signals to control the first CPU 150. It is also possible that the terminal T5 is used as an interface terminal to connect the SOC and an interface to provide wired or wireless communication between the first CPU 150 and external device. It is possible that the buffer 140 may be installed on the SOC. In this case, the terminals T2 and T3 may not be used.

Since the SOC includes the common terminal T1, a conductive signal line may have a first line connected to the common terminal T1, and second lines extended from the first line to each of the first CPU 150 and the RF I/F 120. Therefore, the source file can be read from the first main storage 130 and then distributed to the first CPU 150 and the RF I/F 120. In this case, the SOC may not require two terminals to connect the main storage 130 to the first CPU 150 and the RF I/F 120.

It is possible that a conductive line includes a first line connected to the main storage 130 and second lines extended from the first line and connected to two terminals (two of T1), for example, T11 and T12, formed on the SOC. In this case the two terminals (two of T1), for example, T11 and T12, are connected to the first CPU 150 and the RF I/F 120, respectively. Accordingly, data or signals, for example, the source file, is read from the first main storage 130 and then distributed to each of the first CPU 150 and the RF I/F 120 such that the source file can be simultaneously decoded and transmitted. The source file can be transmitted through the RF transceiver 110 without being decoded.

The antenna may be connected to the SOC through a terminal connected to the first RF transceiver 110. However, it is possible that the antenna can be installed on the SOC.

Referring to FIGS. 4 and 6, the compressed audio/video/graphic files and the display information transmitted by wireless through the first RF transceiver 110 may be provided to the second user device 2000 through a second RF transceiver 210.

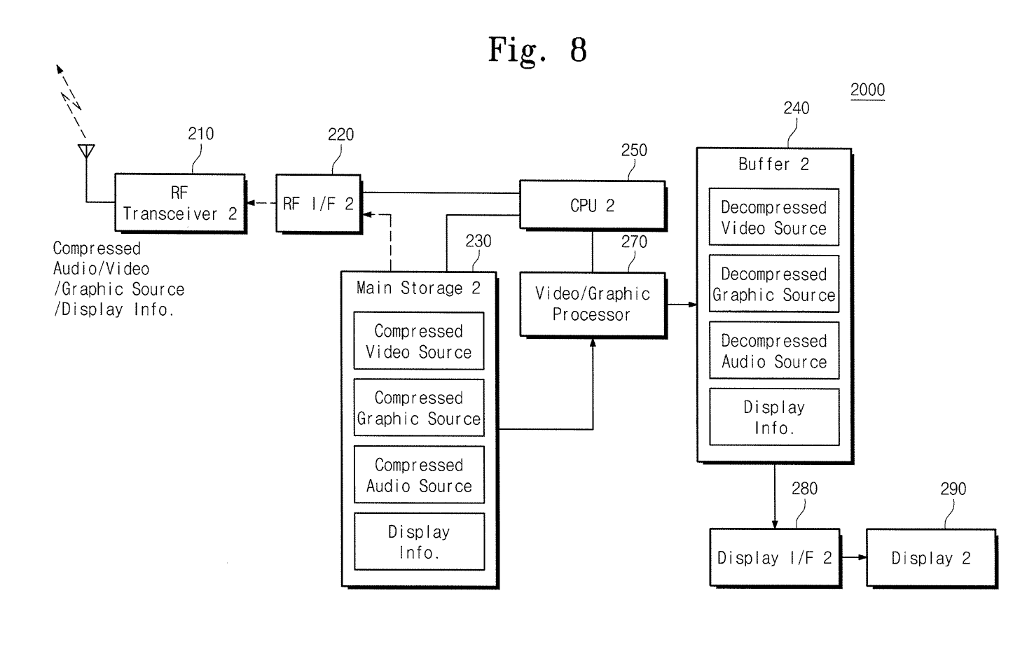

The second user device 2000 may include the second RF transceiver 210, a second RF interface 220, a second main storage 230 (refer to FIGS. 3 and 8), a second buffer 240, a second CPU 250, a video/graphic processor 270, a second display interface 280, and a second display 290. The second RF transceiver 210, the second main storage 230, the second CPU 250, the video/graphic processor 270, and the second display 290 may have the same structures as those shown in FIG. 3. Thus, descriptions thereof will not be repeated.

The compressed audio/video/graphic files and the display information received through the second RF transceiver 210 may be provided to the second RF interface 220 and may be demultiplexed. The demultiplexing result of the second RF interface 220 may be provided to the video/graphic processor 270 in operation S1400.

The video/graphic processor 270 may decode the compressed audio/video/graphic files under the control of the second CPU 250. The decoding result of the video/graphic processor 270 and the display information may be temporarily stored in the second buffer 240. The second buffer 240 may include a random access memory. In the current embodiment, the second buffer 240 includes a DRAM.

The decoding result and the display information stored in the second buffer 240 may be provided to the second display 290 through the second display interface 280 in operation S1500. The second display interface 280 may include an LCD interface, a high-definition multimedia interface (HDMI), and a DisplayPort. The second display 290 may display data received through the second display interface 280 on a screen. The second display 290 may include an LCD or a touch screen. The second display interface 280 and the second display 290 are not limited to particular structures but may have various structures.

Although not shown in FIG. 6, the second user device 2000 may further include a general-purpose interface such as USB and PCIe, and a large-capacity storage such as a HDD. The wireless sharing method of the inventive concept may be applied to other operations such as a streaming operation or a downloading operation for a device connected through the general-purpose interface as well as a display mirroring operation. The general-purpose interface may include a wired/wireless transceiver such as a wired/wireless LAN interface.

The second user device 2000 may perform a wireless data sharing operation for source files provided by an internet service provider (ISP) as well as for source files received by wireless from the first user device 1000. That is, the second user device 2000 may perform a wireless data sharing operation for various kinds of source files and source providers.

As described above, in a first type display mirroring operation of the inventive concept, compressed source files to be displayed on the first user device 1000 may be transmitted to the second user device 2000 before the compressed source files are decoded at the first user device 1000. Then, a decoding operation of the first user device 1000 for the compressed source files to be displayed on the first user device 1000 may be performed in parallel with or substantially at the same time with a decoding operation of the second user device 2000 for the compressed source files received from the first user device 1000. Therefore, a wireless data sharing operation such as the display mirroring operation can be performed without a time delay.

In the inventive concept, the first and second displays 190 and 290 of the first and second user devices 1000 and 2000 may have different resolutions. For example, the resolution of the second display 290 which is a large display may be higher than that of the first display 190 which is a small display.

If a first type display mirroring operation is performed based on transcoding as described above, the resolution of a screen mirrored to the second user device 2000 is determined by the resolution of the first display 190. In this case, although the resolution of the second display 290 is higher than the resolution of the first display 190, the second display 290 displays the screen with a resolution determined by the resolution of the first display 190.

However, in a first type display mirroring operation of the inventive concept, transcoding is not performed, and thus the second user device 2000 can carry out decoding according to the resolution of the second display 290 regardless of the resolution of the first display 190. Therefore, according to the first type display mirroring method of the inventive concept, a high-quality display screen can be provided to users without image degradation. These display characteristics of the inventive concept may be the same in a second type display mirroring operation and a first type display mirroring operation.

When the source file is selected according to a selection unit or an input unit, the selected source file is transmitted to the first CPU 150 and the first RF transceiver 110 such that the first CPU 150 decodes the source file upon receiving, and the first RF transceiver 110 transmits the source file to an external apparatus or device upon receiving without a decoding process.

When the source file is transmitted from the first storage 130 to the first CPU 150 and then decoded to be displayed on a screen of the display 190, the source file can be selected to be transmitted to an external apparatus or device. In this case, a first portion of the source file has been already transmitted to the first CPU 150 and then decoded to be displayed on a screen of the display 190. Accordingly, a second portion (remaining portion) of the source file is read from the main storage 1130 and then transmitted to both the first CPU 150 and the first RF transceiver 110 such that the first CPU decodes the second portion of the source file to be displayed on a screen of the display 190 and the first RF transceiver 110 transmits the second portion of the source file to the external apparatus or device. In this case, the external apparatus, for example, the second user device 2000 receives the second portion of the source file and decodes the second portion of the source file to be displayed on a screen of the display 290.

When the source file stored in the second user device 2000 is transmitted from the second user device 2000 to the first user device 1000, and decoded in both the second user device 2000 and the first user device 1000 to be simultaneously displayed on the screens thereof, another source file stored in the first user device 1000 can be selected or determined to transmit to both the first CPU and the first RF transceiver 110. In this case, the another source file can be decoded in the first CPU 150 and also transmitted to the second user device 2000 through the first RF transceiver 110 and the second RF transceiver 210.

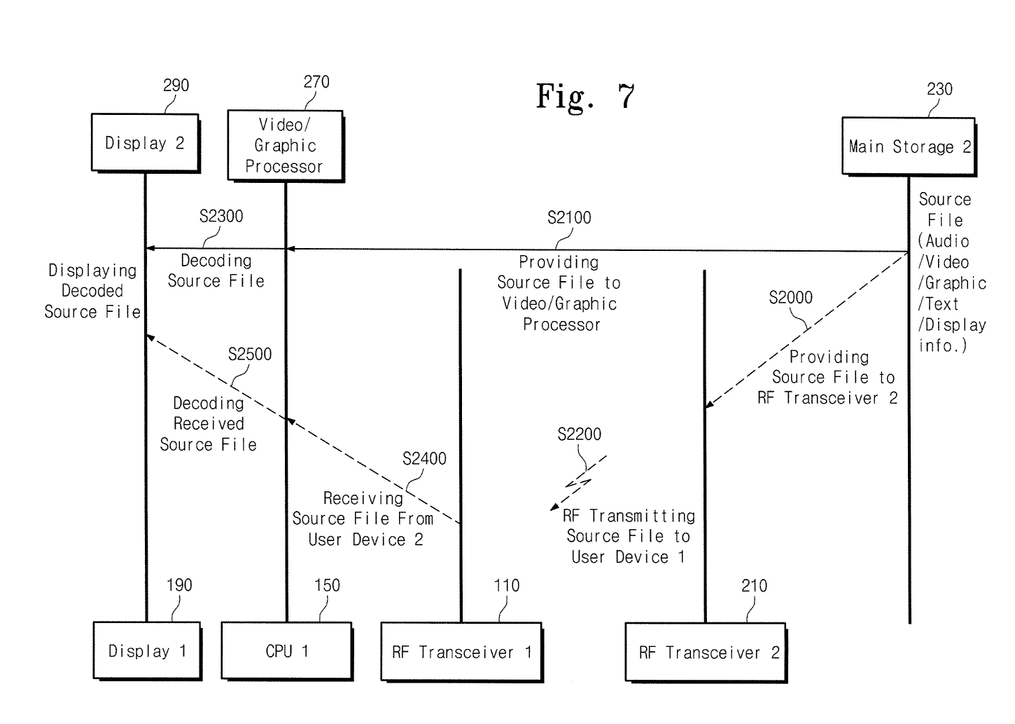

FIGS. 7 through 9 are views illustrating a second type display mirroring operation according to embodiments of the inventive concept.

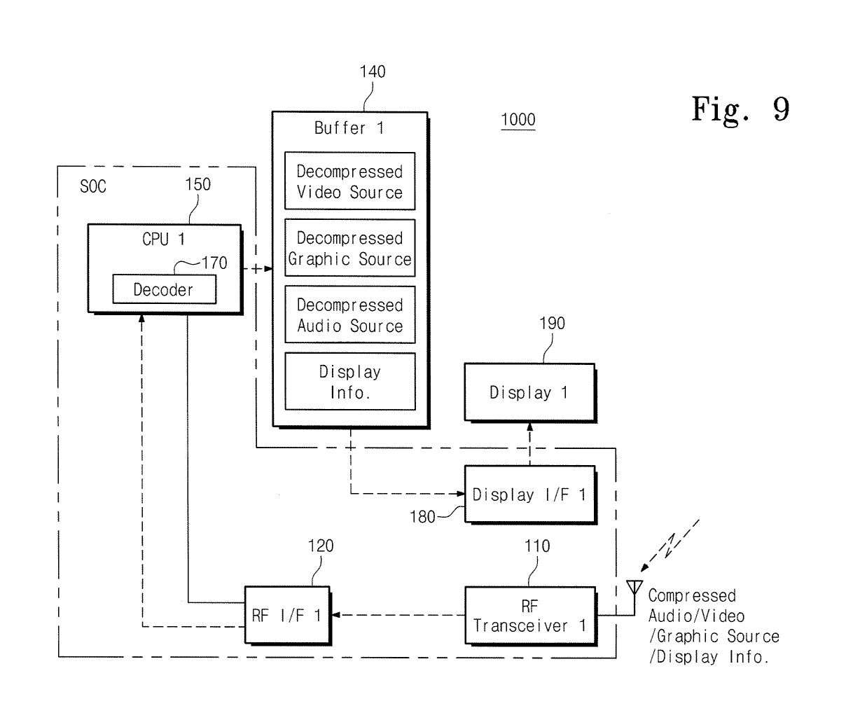

FIG. 7 illustrates data transmitting and receiving processes during a second type display mirroring operation according to an embodiment of the inventive concept. FIG. 8 illustrates a detailed structure of a second user device 2000 configured to perform a second type display mirroring operation according to an embodiment of the inventive concept. FIG. 9 illustrates a detailed structure of a first user device 1000 configured to perform a second type display mirroring operation according to an embodiment of the inventive concept.

According to the inventive concept, a display mirroring operation can be bidirectionally performed. For example, the second user device 2000 operating as a receiving user device in a first type display mirroring operation may start to operate as a transmitting user device if a user requests a second type display mirroring operation.

Referring to FIGS. 7 and 8, if a user requests a second type display mirroring operation, the second user device 2000 provides source files (compressed audio/video/graphic files and display information) stored in a second main storage 230 to a second RF transceiver 210 through a second RF interface 220 in operation S2000 and to a video/graphic processor 270 in operation S2100 under the control of a second CPU 250. The compressed audio/video/graphic files and display information provided to the second RF transceiver 210 may be transmitted to the first user device 1000 through a wireless network such as WUSB in operation S2200.

After or while the compressed audio/video/graphic files and display information are transmitted to the first user device 1000 through the second RF transceiver 210, the video/graphic processor 270 may decode the compressed audio/video/graphic files. The decoding result of the video/graphic processor 270 may be displayed on the second display 290 through the second display interface 280 in operation S2300.

Referring to FIGS. 7 and 9, the compressed audio/video/graphic files and display information transmitted through the second RF transceiver 210 may be received by the first user device 1000 through a first RF transceiver 110 of the first user device 1000. The compressed audio/video/graphic files and display information may be provided to a first CPU 150 through a first RF interface 120 in operation S2400.

The first CPU 150 may include a decoder 170 to decode the compressed audio/video/graphic files. The first CPU 150 may create a screen based on the decoding result of the decoder 170 and the display information, and then the first CPU 150 may display the screen on a first display 190 through a first display interface 180 in operation S2500.

As described above, in a second type display mirroring operation of the inventive concept, the second user device 2000 which operates as a receiving user device in a first type display mirroring operation can be changed to operated as a transmitting user device, and the first user device 1000 which operates as a transmitting user device in a first type display mirroring operation can be changed to operated as a receiving user device.

Furthermore, in a second type display mirroring operation of the inventive concept, source files to be displayed on the second user device 2000 can be transmitted to the first user device 1000 before the source files are decoded at the second user device 2000. Then, a decoding operation of the second user device 2000 for the source files may be performed in parallel with or substantially at the same time with a decoding operation of the first user device 1000 for the source files. Therefore, a wireless data sharing operation, such as the display mirroring operation, can be performed without a time delay. In this case, the first user device 1000 and the second user device 2000 can perform decoding operations according to their own resolutions regardless of the resolution of the other user device. Therefore, according to the first type display mirroring method of the inventive concept, high-quality display images can be provided to users without image degradation.

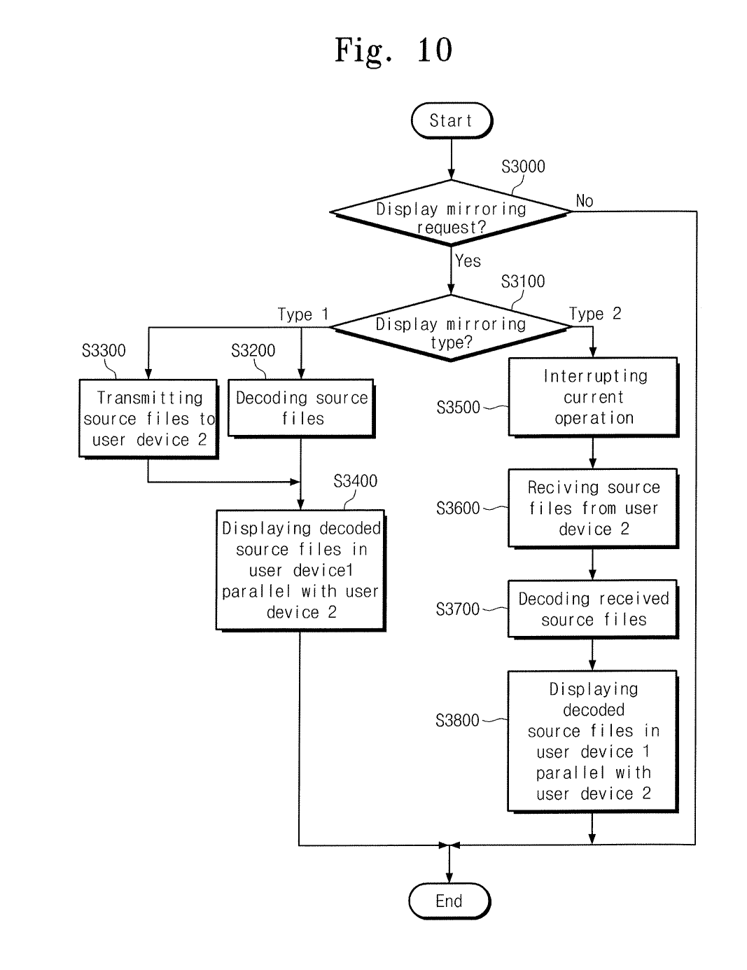

FIG. 10 is a flowchart illustrating an exemplary bidirectional display mirroring method carried out by the first user device 1000 according to according to an embodiment of the inventive concept.

Referring to FIG. 10, the first user device 1000 determines whether there is a display mirroring request from a user in operation S3000. If it is determined that there is a display mirroring request from a user in operation S3000, it is determined whether the display mirroring request is for a first type display mirroring operation or a second type display mirroring operation in operation S3100.

When it is determined that the display mirroring request is for a first type display mirroring operation in operation S3100, the first user device 1000 may decode compressed source files stored in the first main storage 130 in operation S3200, and in parallel with this, the first user device 1000 may transmit the compressed source files (e.g., audio/video/graphic files) and corresponding display information to the second user device 2000 by a wireless communication in operation S3300. In the first type display mirroring operation, the first user device 1000 operates as a transmitting user device, and the second user device 2000 operates as a receiving user device.

In an exemplary embodiment, decoding in operation S3200 and wireless transmitting in operation S3300 of the first user device 1000 may be simultaneously performed. In another example, decoding in operation S3200 may be performed after wireless transmitting in operation S3300. In the current embodiment of the inventive concept, wireless transmitting of the source files may be performed by UWB based WUSB that allows a high transmission rate of several hundreds of Mbps. In this case, since it takes very short time to transmit the source files from the first user device 1000 to the second user device 2000 by a wireless communication, decoding operations of the first and second user devices 1000 and 2000 may be performed substantially at the same time. The source files decoded by the first user device 1000 are displayed on the first display 190 of the first user device 1000 based on the corresponding display information in parallel with a displaying operation of the second user device 2000 in operation S3400.

When the display mirroring request is for a second type display mirroring operation in operation S3100, the first user device 1000 interrupts its current operation in operation S3500 and receives source files and display information of the source files transmitted by wireless from the second user device 2000 in operation S3600. In the second type display mirroring operation, the first user device 1000 operates as a receiving user device, and the second user device 2000 operates as a transmitting user device. The first user device 1000 decodes the received source files in operation S3700. The source files decoded by the first user device 1000 are displayed on the first display 190 of the first user device 1000 based on the display information of the source files in parallel with a displaying operation of the second user device 2000 in operation S3800.

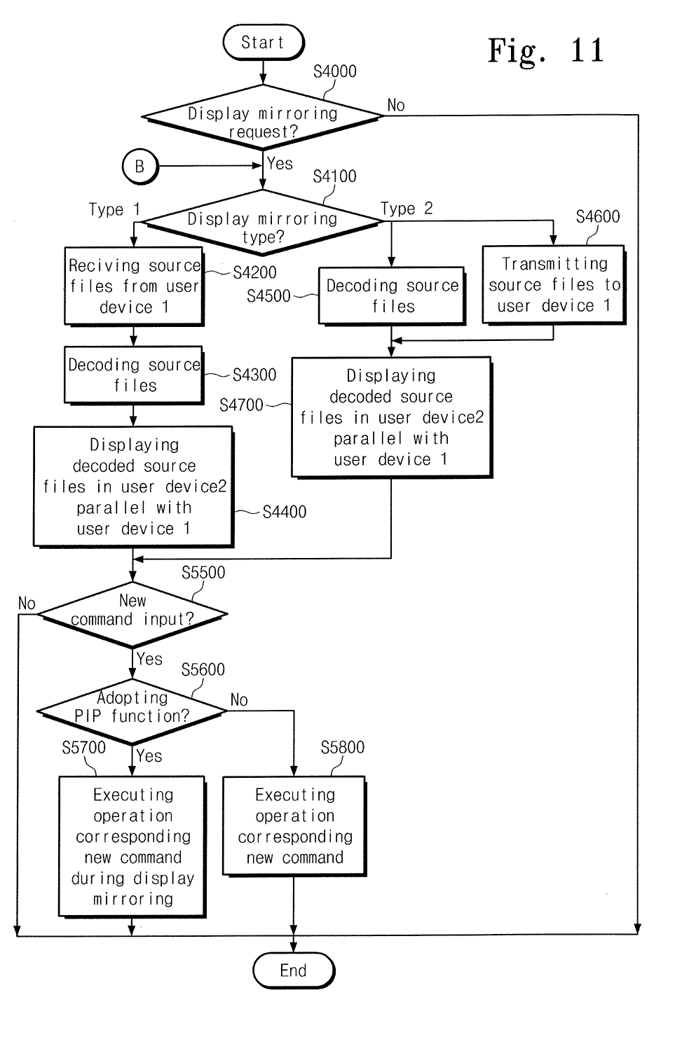

FIG. 11 is a flowchart for explaining an exemplary bidirectional display mirroring method carried out by the second user device 2000 according to an embodiment of the inventive concept.

Referring to FIG. 11, the second user device 2000 determines whether there is a display mirroring request from a user in operation S4000. In operation S4000, if it is determined that there is a display mirroring request from a user, it is determined whether the display mirroring request is for a first type display mirroring operation or a second type display mirroring operation in operation S4100. In a first type display mirroring operation, the first user device 1000 operates as a transmitting user device, and the second user device 2000 operates as a receiving user device.

When it is determined that the display mirroring request is for a first type display mirroring operation in operation S4100, the second user device 2000 receives compressed source files (e.g., audio/video/graphic files) and display information of the source files from the first user device 1000 by a wireless communication in operation S4200. The compressed source files and the corresponding display information may be transmitted from the first user device 1000 to the second user device 2000 before or while the first user device 1000 decodes the source files for displaying the source files. Next, the second user device 2000 decodes the received source files in operation S4300. The source files decoded by the second user device 2000 are displayed on the second display 290 of the second user device 2000 based on the corresponding display information in parallel with a displaying operation of the first user device 1000 in operation S4400. Then, the method proceeds to operation S5500.

On the other hand, in operation S4100, if it is determined that the display mirroring request is for a second type display mirroring operation, the second user device 2000 may decode compressed source files to be displayed in operation S4500, and in parallel with this, the second user device 2000 may transmit the compressed source files and corresponding display information to the first user device 1000 by a wireless communication in operation S4600. In a second type display mirroring operation, the second user device 2000 operates as a transmitting user device, and the first user device 1000 operates as a receiving user device.

In an exemplary embodiment, decoding in operation S4500 and wireless transmitting in operation S4600 of the second user device 2000 may be simultaneously performed. In another example, decoding in operation S4500 may be performed after wireless transmitting in operation S4600. In the current embodiment of the inventive concept, wireless transmitting of the source files may be performed by UWB based WUSB. In this case, since it takes very short time to transmit the source files from the second user device 2000 to the first user device 1000 by wireless, decoding operations of the first and second user devices 1000 and 2000 may be performed substantially at the same time.

The source files decoded by the second user device 2000 in operation S4500 may be displayed on the second display 290 of the second user device 2000 based on the corresponding display information in parallel with a displaying operation of the first user device 1000 in operation S4700.

When is determined whether there is a new command from a user during the display mirroring in operation S5500. If it is determined that there is a new command from a user in operation S5500, it may be determined whether the second user device 2000 has a picture in picture (PIP) function in operation S5600. The PIP function is technology of displaying a plurality of screens on a single display. In an exemplary embodiment, the second user device 2000 may be an A/V device including a large display and capable of displaying a plurality of screens on the display by technology such as PIP and picture by picture (PBP).

When it is determined that the second user device 2000 has a PIP function in operation S5600, the second user device 2000 may execute an operation corresponding to the users' new command while executing the display mirroring in operation S5700. As a result, a display mirroring screen and at least one screen corresponding to the user's new command may be simultaneously displayed on the second display 290. In this way, while performing a display mirroring operation, the second user device 2000 can executes another function or functions in response to a user's command.

On the other hand, in operation S5600, it is determined that the second user device 2000 does not has a PIP function, the second user device 2000 may interrupt its display mirroring operation selectively and perform an operation corresponding to the user's new command in operation S5800. For example, if a first type display mirroring operation in which the second user device 2000 operates as a receiving user device is currently performed, the second user device 2000 may interrupt its current display mirroring operation to operate in response to the user's new command. If a second type display mirroring operation in which the second user device 2000 operates as a transmitting user device is currently performed, the second user device 2000 may operate according to the user's new command without interrupting its current display mirroring operation. In this case, a result of the new operation of the second user device 2000 may be provided to the first user device 1000 by a display mirroring operation.

As described above, in the display mirroring method of the inventive concept, compressed source files and corresponding display information are directly transmitted from a transmitting user device to a receiving user device before the transmitting user device decodes the source files for displaying the source files. Therefore, during a display mirroring operation, it is unnecessary to compress source files again before transmitting the source files, and thus, decoding of re-compressed source files is unnecessary. As a result, bidirectional display mirroring is possible between different user devices without a time delay.

In addition, since user devices can decode source files individually according to their operational characteristics or display resolutions, display mirroring can be carried out without image deterioration caused by influence of the resolution of the other user device. Furthermore, if a user device has a multi-display function such as a PIP function, the user device can perform at least one additional function in response to a user's request without affecting its current display mirroring operation.

With reference to FIG. 11, an explanation has been given on the case where a new command is input from a user while a second type display mirroring operation is performed. This case is merely an example of the inventive concept. For example, operation S5500 to operation S5800 shown in FIG. 11 may also be performed during a first type display mirroring operation.

The above-described display mirroring method may be an exemplary display mirroring method of the inventive concept. For example, the display mirroring method of the inventive concept can be applied to other operations such as a data streaming operation and a downloading operation among different kinds of user devices as well as the same kinds of user devices.

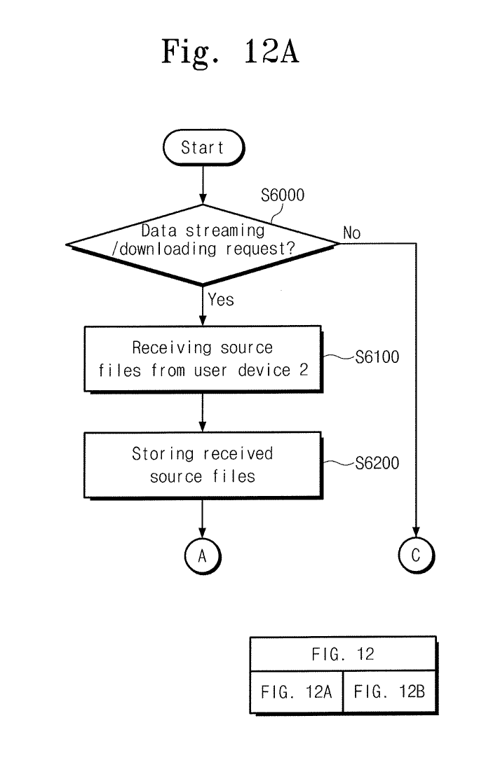

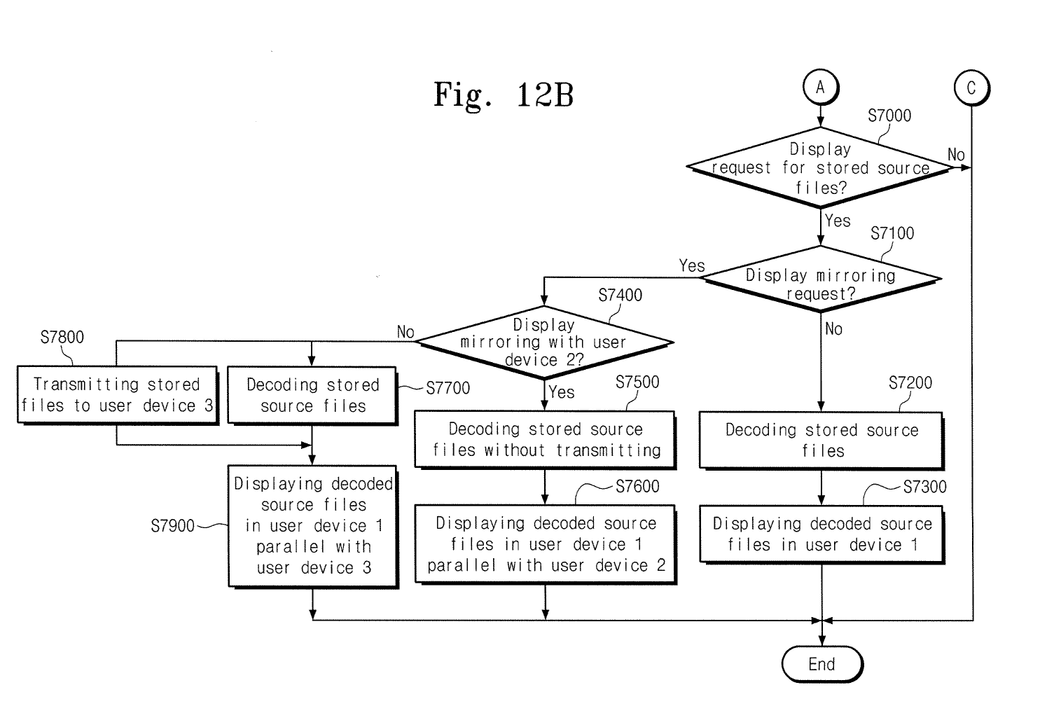

FIGS. 12A and FIG. 12B are flowcharts for explaining an exemplary data streaming/downloading method carried out by the first user device 1000 according to embodiments of the inventive concept. FIGS. 12A and 12B illustrates an exemplary case where a wireless data streaming/downloading operation and a display mirroring operation are combined by a wireless data sharing method executable by the first user device 1000.

Referring to FIG. 12A, the first user device 1000 may determine whether a user requests a data streaming/downloading operation for transmitting multimedia contents from the second user device 2000 to the first user device 1000 in operation S6000. For example, various source files may be stored in the second user device 2000 which is configured as an A/V device having a large display. Source files of the multimedia contents may be stored in the main storage of the second user device 2000 after being compressed. In response to a user's request, various source files stored in the second user device 2000 may be selectively streamed/downloaded to the first user device 1000.

Streaming is a method of transmitting and reproducing audio, video, or multimedia data. In the streaming method, data are transmitted like a continuous stream of wafer. According to the streaming method, although audio, video, or multimedia data are not completely downloaded, they can be displayed while receiving data packets in real time.

In operation S6000, if it is determined that there is a streaming/downloading request from a user, the source files of multimedia contents and corresponding display information are streamed/downloaded from the second user device 2000 to the first user device 1000 in operation S6100. In operation S6100, wireless transmission of the source files may be performed according to UWB based WUSB for guaranteeing a high transmission rate. However, this is an example of the inventive concept. That is, the inventive concept is not limited thereto. Various wireless networks may be used.

The source files stored in the second user device 2000 in a compressed state may be directly transmitted to the first user device 1000 without an additional transcoding operation. In this case, a receiving user device (that is, the first user device 1000) is not necessary to decode transcoded data, and thus high-rate wireless data sharing is possible among user devices without a time delay.

The source files of multimedia contents and the corresponding display information streamed/downloaded from the second user device 2000 in operation S6100 are stored in the main storage or buffer of the first user device 1000 in operation S6200. The source files stored in operation S6200 may be reproduced in real time or later according to a user's request. In the case where the source files stored in the first user device 1000 are reproduced later according to a user's request, the first user device 1000 is used as storage. In this case, as well as multimedia contents, other kinds of source files such as text files and data files may be stored in the first user device 1000.

Referring to FIG. 12B, before reproducing the source files stored in the first user device 1000, the first user device 1000 may determine whether a user requests reproduction of the source file(s) stored in the first user device 1000 in operation S7000. If it is determined in operation S7000 that a user requests reproduction of the source files streamed/downloaded to the first user device 1000, it may be determined whether display mirroring is requested for the source files to be reproduced in operation S7100.

When it is determined that display mirroring is not requested for the source files to be displayed on the first user device 1000 (that is, for the source files streamed/downloaded from the second user device 2000 to the first user device 1000) in operation S7100, the source files are decoded in operation S7200, and the decoding result is displayed on the first user device 1000 with reference to the display information corresponding to the decoded source files in operation S7300.

When it is determined that display mirroring is requested for the source files to be displayed on the first user device 1000 in operation S7100, it is determined whether the display mirroring operation is performed in association with the second user device 2000 in operation S7400.

When it is determined that the display mirroring operation is performed in association with the second user device 2000 in operation S7400, the source files to be displayed on the first user device 1000 are decoded by the first user device 1000 in operation S7500. In this case, since the source files to be displayed on the first user device 1000 are already stored in the second user device 2000, transmission of the source files from the first user device 1000 to the second user device 2000 is not necessary. Although not shown in FIG. 12B, while the source files to be displayed on the first user device 1000 are decoded, the second user device 2000 may decode the source files stored in the second user device 2000. These operations of the second user device 2000 may be controlled by a predetermined request signal transmitted from the first user device 1000 to the second user device 2000 in response to a user's request. Various kinds of requests signals may be transmitted between the first and second user devices 1000 and 2000 to perform a display mirroring operation.

The source files decoded by the first user device 1000 in operation S7500 may be displayed on the first display 190 based on the corresponding display information. While the decoded source files are displayed on the first display 190, a decoding result of the same source files may be displayed on the second user device 2000 in operation S7600.

If it is determined that the display mirroring operation is not performed in association with the second user device 2000 in operation S7400, the source files to be displayed on the first user device 1000 (that is, the source files streamed/downloaded from the second user device 2000 to the first user device 1000) may be decoded by the first user device 1000 in operation S7700, and in parallel with this, the source files and the display information corresponding to the source files may be transmitted to a third user device by wireless in operation S7800. In this case, the first user device 1000 operates as a transmitting user device, and the third user device operates as a receiving user device. The third user device may be any user device except for the second user device 2000 which is the first provider of the source files. For example, the third user device may be the same kind of device as the first user device 1000 or different in kind from the first user device 1000 and the second user device 2000. In another example, the third user device may be the same kind of device as the second user device 2000 but a device not having the source files. The third user device is not limited to a particular device but can be selected from various devices.

In an exemplary embodiment, the decoding operation S7700 of the first user device 1000 and the wireless transmission operation S7800 may be simultaneously performed. In another embodiment, the decoding operation S7700 may be performed after the wireless transmission operation S7800 is performed. Although not shown in FIG. 12B, while the source files to be displayed on the first user device 1000 are decoded, the third user device may decode the source files transmitted from the first user device 1000.

In the current embodiment of the inventive concept, wireless transmission of the source files may be carried out by UWB based WUSB for a high transmission rate of several hundreds of Mbps. In this case, since it takes very short time to transmit the source files from the first user device 1000 to the third user device by wireless, decoding operations of the first user devices 1000 and the third user device may be performed substantially at the same time. The source files decoded by the first user device 1000 are displayed on the first display 190 of the first user device 1000 based on the corresponding display information in parallel with a displaying operation of the third user device in operation S7900.

Next, an explanation will be given on a data streaming/downloading method for the second user device 2000 that provides source files.

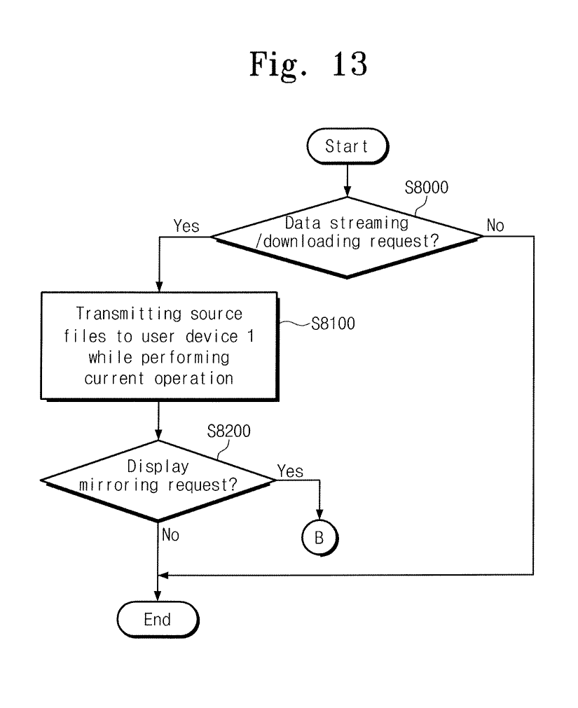

FIG. 13 is a flowchart for explaining an exemplary data streaming/downloading method carried out by the second user device 2000 according to an embodiment of the inventive concept.

FIG. 13 is a flowchart for explaining an exemplary data streaming/mirroring method carried out by the second user device 2000 according to an embodiment of the inventive concept. FIG. 13 illustrates an exemplary case where a wireless data streaming/downloading operation and a display mirroring operation are combined by a wireless data sharing method executable by the second user device 2000.

Referring to FIG. 13, the second user device 2000 may determine whether a user requests a data streaming/downloading operation for transmitting multimedia contents from the second user device 2000 to the first user device 1000 in operation S8000.

When it is determined that there is a streaming/downloading request from a user in operation S8000, the second user device 2000 transmits compressed source files of the multimedia contents stored in its main storage to the first user device 1000 by wireless without an additional transcoding operation in operation S8100. When the source files are transmitted in operation S8100, display information corresponding to the source files may be transmitted together with the source files.

In operation S8100, wireless transmission of the source files may be performed according to UWB based WUSB for a high transmission rate. According to the data transmission features of the current embodiment of the inventive concept, compressed source files stored in a transmitting user device (the second user device 2000) are directly transmitted to a receiving user device (the first user device 1000), and thus additional transcoding and resultant decoding are not necessary. Therefore, wireless data sharing between the first and second user devices 1000 and 2000 are possible without a time delay.

The wireless data sharing operation of the current embodiment can be performed together with the above-described display mirroring operation.

For this, the second user device 2000 may determine whether a user requests display mirroring in operation S8200. In operation S8200, if it is determined that a user requests display mirroring, the method may proceed to operation S4100 of FIG. 11 (refer to “B” in FIGS. 13 and FIG. 11) to perform a display mirroring operation. At this time, the second user device 2000 performs the same display mirroring operation as that shown in FIG. 11. Thus, a description thereof will not be repeated.

With reference to FIGS. 12 and 13, an explanation has been given on the case where a first or second type display mirroring operation is performed when stored data are displayed by a streaming/downloading operation. However, this is a mere example of the inventive concept. For example, according to the inventive concept, a streaming/downloading operation may be performed in parallel with a first or second type display mirroring operation.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to the wireless sharing system of the inventive concept, compressed source files stored in a transmitting user device can be directly transmitted from a receiving user device during a wireless data sharing or display mirroring operation. As a result, in a wireless data sharing or display mirroring operation, a transmitting user device is not necessary to decode compressed source files and transcode decoded display data, and a receiving user device is not necessary to decode received transcoded data. Therefore, display mirroring and wireless sharing of source files can be effectively performed without a time delay under limiting conditions such as the data transmission rate and bandwidth of a wireless network and power consumption limitation.

In addition, during a wireless data sharing or display mirroring operation, transmitting user device and receiving user device can decode source files individually without influence of the resolution of the other device. Therefore, display mirroring and wireless data sharing of multimedia contents can be performed without image deterioration. The display mirroring and wireless data sharing operations of the inventive concept can be bidirectionally performed among different kinds of user devices. The inventive concept is not limited to a particular user device but can be applied to various user devices, and the wireless sharing method and display mirroring method of the inventive concept can be applied to various user devices.

According to the inventive concept, display mirroring and wireless sharing of source files can be effectively performed in a portable electric device without time delay and image deterioration under limiting conditions such as data transmission rate and bandwidth of a wireless network and power consumption limitation.

In addition, according to the inventive concept, bidirectional display mirroring and multimedia contents sharing are possible among a portable electric device and the same or different kinds of devices.

Although a few embodiments of the present invention have been shown and described, it would be appreciated by those skilled in the art that changes may be made in these embodiments without departing from the principles and spirit of the general inventive concept, the scope of which is defined in the claims and their equivalents.

What is claimed is:

1. An electronic apparatus comprising:
a transceiver;
a decoding unit; and
a controller to control the transceiver and the decoding unit to simultaneously transmit a source file having encoded data to an external apparatus without decoding the encoded data of the source file and decode the encoded data of the source file.

2. The apparatus of claim 1, wherein the transceiver, the decoding unit, and the controller are embedded in a single integrated chip.

3. The apparatus of claim 2, further comprising:
a storage unit having a single common terminal connected to the transceiver and the decoding unit of the single integrated chip such that the source file is read and simultaneously transmitted to both the transceiver and the decoding unit.

4. The apparatus of claim 1, wherein:
the source file comprises a first portion and a second portion;
the decoding unit receives and decodes the first portion of the stored source file; and
the transceiver receives and transmits the second portion of the stored source file when the decoding unit receives and decodes the second portion of the stored source file.

5. The apparatus of claim 4, wherein the source file is selected to be transmitted to the external apparatus according to a selection signal during decoding the first portion of the stored source file so that the second portion of the source file is simultaneously decoded and transmitted to the external apparatus.

6. The apparatus of claim 1, further comprising:
a selection unit to generate a selection signal as a command corresponding to selection of one of mirroring modes.

7. The apparatus of claim 1, wherein the controller selects the external apparatus and reads the source file and simultaneously transmit the read source file to the transceiver and the decoding unit according to the selection of the external apparatus.

8. The apparatus of claim 1, wherein the transceiver receives a second source file having encoded data from the external apparatus, and the decoding unit decodes the encoded data of the received second source file and outputs the decoded data to be displayed as a second image on a screen.

9. An electronic apparatus comprising:
a single integrated chip formed with a transceiver, a decoding unit, and a controller as a single monolithic body,
wherein the controller controls the transceiver and the decoding unit to simultaneously transmit a source file having encoded data to an external apparatus without decoding the encoded data of the source file and decode the encoded data of the source file.

10. The apparatus of claim 9, further comprising:
the single integrated chip having a common terminal to be connected to a storage unit storing the source file so that the transceiver and the decoding unit simultaneously receives the source file from the storage unit.

11. The apparatus of claim 9, further comprising:
a storage unit to store the source file,
wherein the controller controls the storage unit, the transceiver, and the decoding unit such that the source file is read from the storage unit and the read source file is simultaneously transmitted the transceiver and the decoding unit.

12. The apparatus of claim 9, wherein:
the source file comprises a first portion and a second portion;
the decoding unit receives and decodes the first portion of the stored source file; and
the transceiver receives and transmits the second portion of the stored source file when the decoding unit receives and decodes the second portion of the stored source file.

13. The apparatus of claim 12, further comprising:
a selection unit to select at least one of the first portion and the second portion.

14. The apparatus of claim 9, wherein:
the source file comprises source files; and
at least one of the source files is selected according to a selection of a selection unit connected to the single integrated chip such that the selected source file is simultaneously transmitted to the transceiver and the decoding unit.

15. The apparatus of claim 9, wherein:
the controller controls the transceiver to transmit the source file without decoding by the decoding unit to the external apparatus in a first mirroring mode; and
the controller controls the transceiver to receive another source file from the external apparatus in a second mirroring mode.

16. The apparatus of claim 9, wherein the source file includes sub-source files, and the controller generates a list signal representing the sub-source files, selects at least one of the sub-source files, and controls the selected at least one of the sub-files to be simultaneously transmitted to the transceiver and the decoding unit.

17. The apparatus of claim 9, further comprising:
a selection unit to select the external apparatus and the source file such that the selected source file is simultaneously transmitted to the decoding unit and the selected external apparatus through the transceiver.

18. An electronic apparatus comprising:
a storage unit to store a source file with encoded data;
a single integrated chip connected to the storage unit, and having a transceiver, a decoding unit, and a controller to control the transceiver and the decoding unit to simultaneously receive the source file and decode the source file and transmit the source file to an external apparatus; and
a display unit connected to the single integrated chip to display the decoded source file.

19. The apparatus of claim 18, wherein the transceiver comprises an RF transceiver to wirelessly communicate with an external apparatus.

20. The apparatus of claim 18, further comprising:
a housing to accommodate the storage unit, the single integrated chip, and the display unit therein, and to communicate with the external apparatus through the transceiver.

21. The apparatus of claim 18, further comprising:
a selection unit connected to the single integrated chip to select the external apparatus and the source file.

22. The apparatus of claim 21, wherein the display unit comprises a touch screen to display the decoded source file, and the selection unit is included in the touch screen to generate a selection signal to select the apparatus and the source file.

23. A method of an electronic apparatus, the method comprising:
storing a source file with encoded data in a storage unit; and
transmitting the stored source file from the storage unit to a single integrated chip having transceiver, a decoding unit, and a controller to control the transceiver and the decoding unit to receive the source file and simultaneously decode the source file and transmit the source file to an external apparatus.

24. The method of claim 23, further comprising:
displaying the decoded source file on a display unit.

25. The method of claim 24, further comprising:
selecting the external apparatus and the source file using a selection unit connected to the signal integrated chip.
